(19) United States
(12) Patent Application Publication
(10) Pub. No.: US 2006/0138731 A1
(43) Pub. Date: Jun. 29, 2006

(54) Cylinder head gasket

(76) Inventors: Jurgen Stetter, Siegen (DE); Klaus Schmitt, Grunebach (DE); Ralf Flemming, Langenbach (DE); Klaus Weckbecker, Wermelskirchen (DE)

Correspondence Address: Robert L Stearns;Dickinson Wright, 38525 Woodward Avenue, Bloomfield Hills, MI, 48304, US

(21) Appl. No.: 10/562,194

(22) PCT Filed: Apr. 27, 2004
(86) PCT No.: PCT/DE04/00877

§ 371 Date: Dec. 23, 2005

(30) Foreign Application Priority Data
Jun. 24, 2003 (DE) 103 28 158.4

(51) Int. Cl. F02F 11/00

(52) U.S. Cl. 277/594

(57) ABSTRACT

Cylinder head gasket for an internal combustion engine, insertable for sealing of components, at least one of which has a T-junction formed region, containing at least one functional position and at least one distance position as well as at least one additional gasket element, which is provided in the region of the T-junction, whereby the distance position is provided at least in the region of the T-junction with at least one recessed region serving for the intake of the additional gasket element.

### SPECIFICATION

The invention concerns a cylinder head gasket for an internal combustion engine, adjustable for sealing of components, at least one of which has a T-junction region, containing at least one functional position, at least one positional distance and at least one additional sealing element, which are provided in the region of the T-junction.

DE-A 198 45 320 describes a cylinder head gasket for an internal combustion engine, which is laterally screwed onto an engine block, and the cylinder head gasket housing is sealed for uptake of driving means, whereby an elastic seal consisting of elastomeric material is provided for the sealing of the housing of the frontal end region of the cylinder head gasket, which extends itself into a space in the mounting state, which results in a tolerance-conditioned engine head housing and cylinder head gasket. At the frontal end region of the cylinder gasket there is at least one counterbore, the depth of which radial inwards of the end region decreases continually. The elastic seal is absorbed in the counterbore, without protruberance outwardly over the end region of the cylinder head gasket, whereby the counterbore accompanying the structure of the cylinder head gasket is deformable due to such sealing surface compression, so that the seal to the frontal end region is displaced. Here the danger arises, that with the tenseness of cylinder head and engine block, the portion of the gasket element protruding outwardly will be sheared off, so that an effective seal is not realizable.

In EP A 1 013 974 a seal structure is described, which also has a T-shaped formed seal region. For one to be deployed, at least from an existing surface gasket sheet, with recesses in the T-shaped seal region, in which a paste-type sealing element is inserted, it concludes with the sheet in a direction frontally and protrudes over the other front side in the direction of the T-shaped seal position over this front surface. Also here it is possible that with the compression of the components, a shear of the seal element takes place, so that no adequate sealing in the T-shaped region can be ensured.

In many cases surface seals of this kind are inserted in the area of the so-called 3-corner groups of an internal combustion engine, composed of chain housing, engine head and engine block. For example, the engine head is a unit above the chain housing and the engine block, so in extreme cases, this can result in a shelter of the chain housing opposite to the engine block. The sealing of such a difference in height can no longer be realized only through the sealing elements, as they are described in the state of the art. The functionality of sealing elements of this type is assumed only if they are exclusively elastic, that is, are deformed in the power shunt.

The object of the invention is that a cylinder head gasket species is to be improved further with the effect that it also insertable for permanent sealing of differences in height to each other exhibited by components sealed against each other, and particularly is exclusively elastic in the power shunt and is not plastically deformable.

This problem is thus solved, in that the positional distance, at least in the region of the T-junction is provided with at least one recessed region for intake of the additional serving sealing elements.

Important improvements of the subject matter of the invention are cited in the dependent claims.

The recessed region is advantageously manufactured by stamping, whereby the sealing element only partially fills in the recessed region, but protrudes over the opening area. With the compression of the sealed components, particularly in the aforementioned 3-corner group, only the elastically deformable material of the sealing elements can draw aside in the still available free space of the recessed area and partially fill same elastically. In view of these measures, a destruction of the additional sealing element, since it is exclusively elastic, i.e., is deformed in the power shunt, is excluded in each case.

The additional sealing element, for instance, is formed by, e.g, an injected silicone worm, introduced in the recessed area, which—as already mentioned—fills up only a partial region of the recessed area. The distance position works together advantageously on the sealing element side with at least one of the functional positions, which is furnished with a recess in the region of the sealing element.

The cross-section of the recessed region is another than that of the recess of the functional position in the region of the sealing element, whereby, according to a further conception of the invention, the stamped recessed region in respect to its surface is preferably larger than the recess of the functional position.

Thereby it is possible that a larger material amount of the silicone worm is insertable in the recessed region, whereby at the same time the area of the power shunt for this worm is enlarged. This implies, that outside of the recess below the functional position as well, no destruction of the silicone worm takes place, since here also a power shunt still exists by means of the recessed region.

By means of a selective combination of recessed area of the distance position and recess, further hollows, respectively, in the functional position, the flow movement of the silicone worm with the compression of the sealed components can be influenced to such an extent that the silicone worm deforms in the region, i.e. can extend, in which place, additional flow space, respectively, is provided, in which the silicone worm can extend itself without destruction.

The subject matter of the invention is exemplified by means of a practical embodiment in the drawing and is described as follows. It shows:

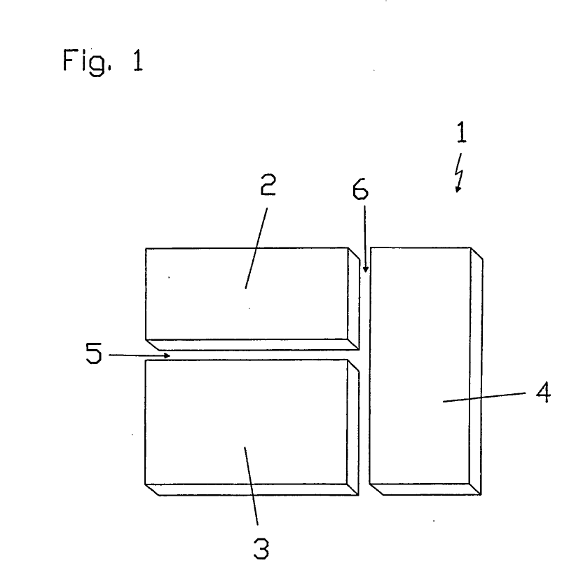

FIG. 1 Principal outline of a possible construction form of an internal combustion engine;

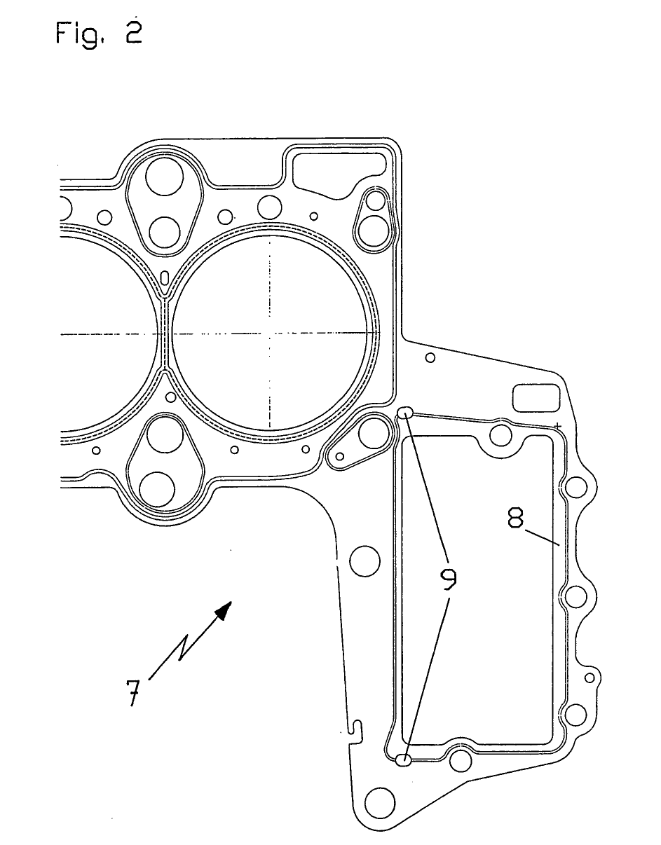

FIG. 2 Partial view of a cylinder gasket head for the sealing of the principle construction form shown in FIG. 1;

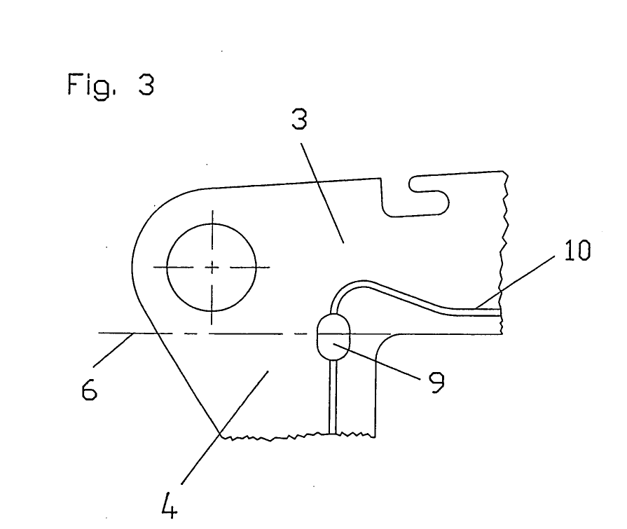

FIG. 3 Partial view of the cylinder gasket head according to FIG. 2 in the engine block—chain housing region;

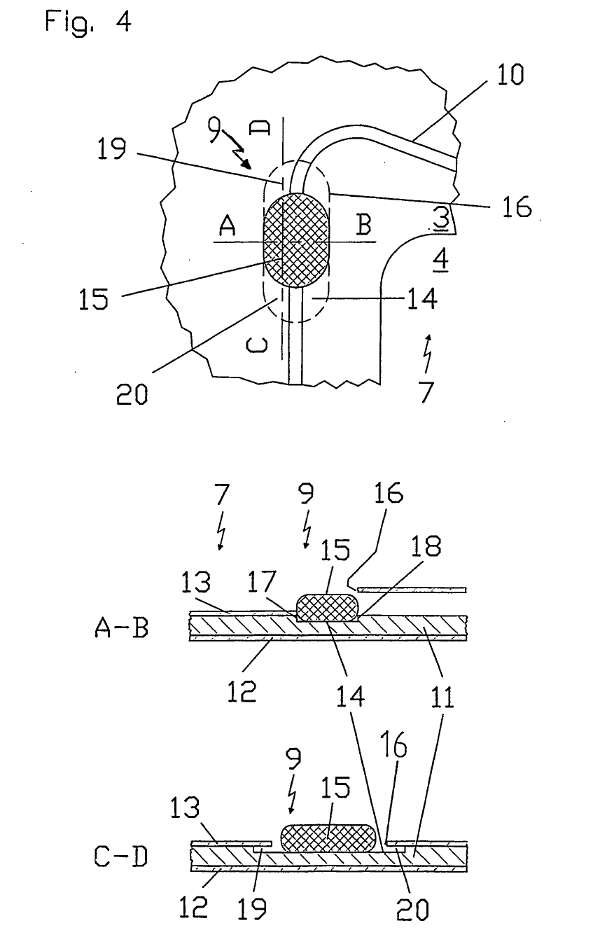

FIG. 4 Partial view of the additional gasket region according to FIG. 3 in the top view on one side and in various sections on other side;

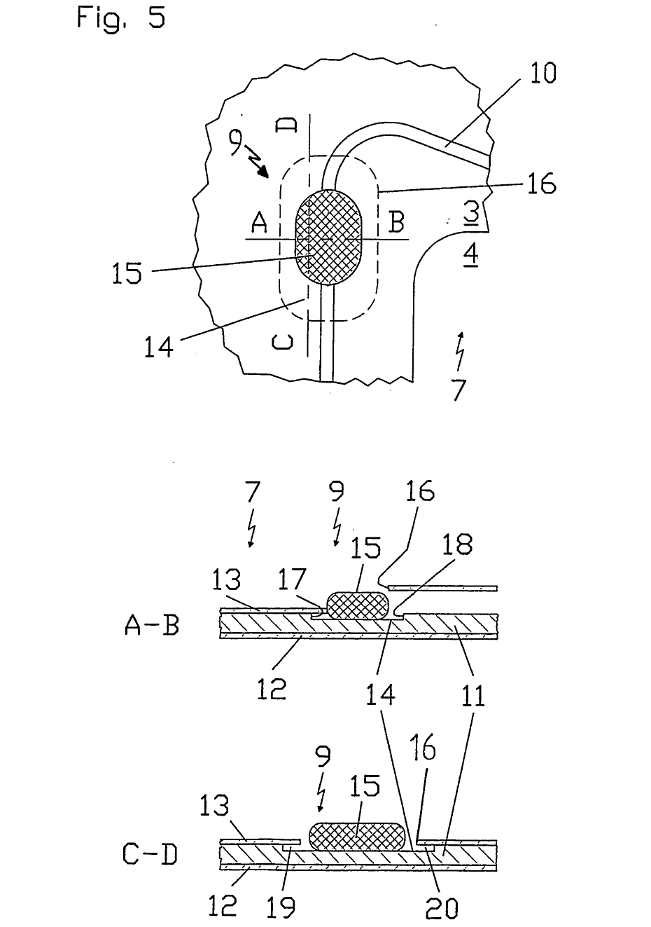

FIG. 5 Additional sealing region shaped alternatively to FIG. 4;

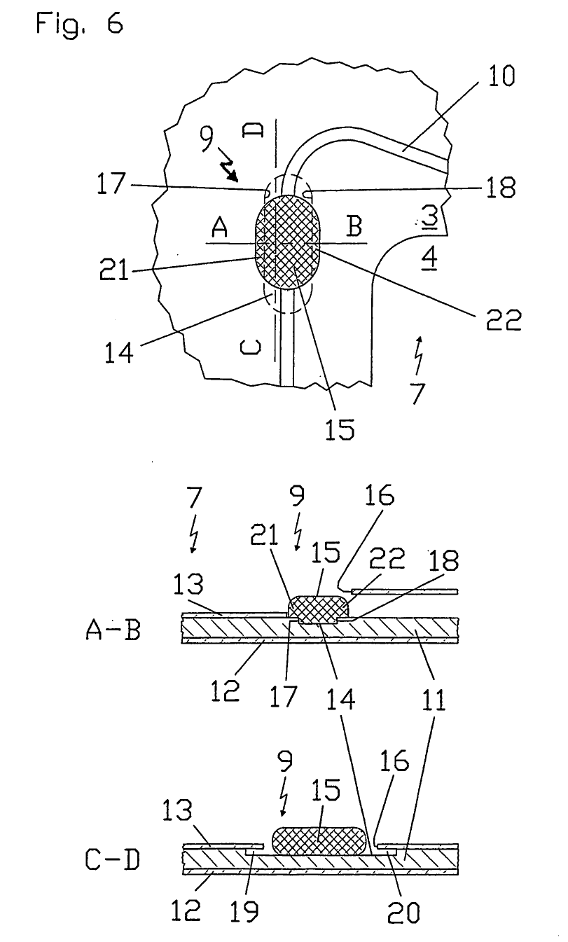

FIG. 6 Another alternative to FIGS. 4 and 5;

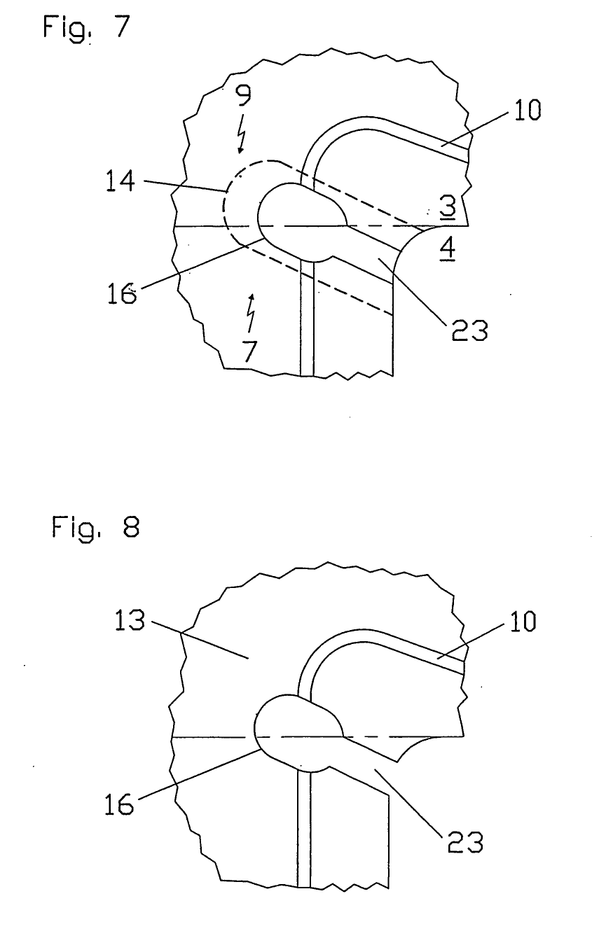

FIG. 7 Top view at an additional gasket region without sealing element;

FIG. 8 Partial view of the functional position according to FIG. 7;

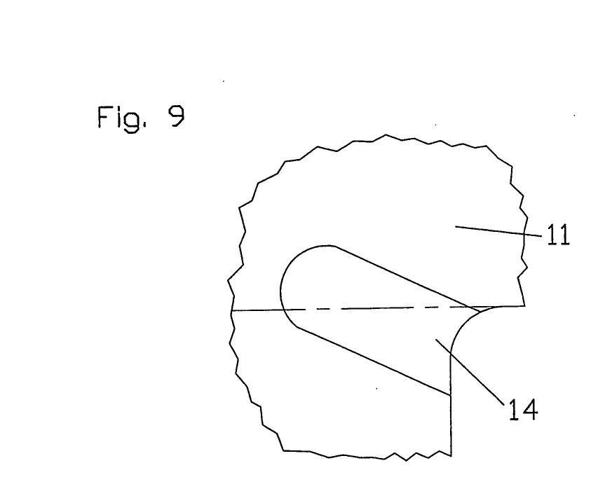

FIG. 9 Partial view of the distance position according to FIG. 7;

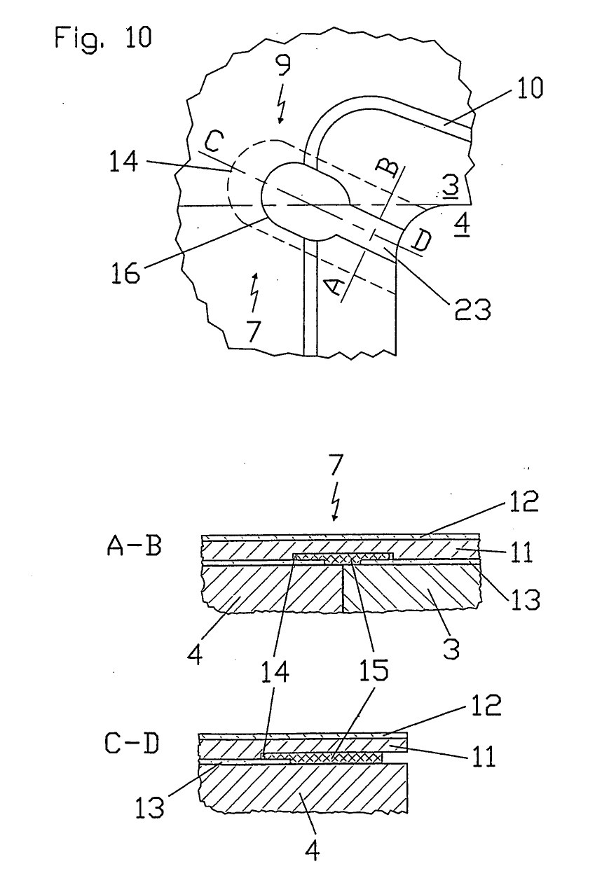

FIG. 10 Partial view of the cylinder gasket head according to FIG. 2 in built-in condition, top view on one side and in various sections on the other side.

FIG. 1 shows a possible construction form of an internal combustion engine 1, containing a cylinder head 2, a cylinder block 2, a cylinder block 3 and also a chain housing 4. In space 5 between cylinder head 2 and cylinder block 3 a cylinder gasket head not shown here is positioned, which also overlaps the space 6 between cylinder head 2/cylinder block 3 and chain housing 4. the spaces 5, 6 define the so-called T-junction.

FIG. 2 shows an indicated-only cylinder gasket head 7, whereby region 8 is furnished for the sealing of the chain housing 4. The cylinder head gasket 7 is—as defined more closely in the following figures—formed in multilayers and is provided in the region of the here not recog-nizable T-junction (spaces 5, 6) with additional sealing region 9.

FIG. 3 shows the additional seal region 9 as partial views, which covers the space 6 between cylinder block 3 and chain housing 4. Half seams 10 are provided between the seal regions 9 in this example.

FIG. 4 shows a partial view of FIG. 3. Recognizable in this example is the other oval shaped seal region 9, in the top view on one side and in sections A-B, C-D on the other side. Further recognizable is the reinforcing half seam 10. The cylinder block 3 and also the chain housing 4 are indicated. The cylinder head gasket 7 is shaped in this example from a distance position 11 and two functional positions 12, 13. According to the invention in the distance position 11 a recessed region 14 is introduced, especially by stamping, which absorbs an additional seal element 15 in the form of an elastic silicone worm. The seal element sided functional position 13 is provided with a recess 16, which—as, in particular, the section C-D is to be taken—which covers over the recessed region 14 in part. Consequently, the cross-sectional surface of the recessed region 14 is larger than that of the hollow 16 in the functional position 13. In this example the silicone worm 15 should at least touch the boundary region 17, 18 of the recessed region 14, but nevertheless forms within the recessed region 14 free spaces 19, 20. The height of the silicone worm 15 is greater than the sum of the depth of the recessed region as well as the wall thickness of the functional position 13, so that it protrudes out with specified distance over both. Only with compression of the components 3, 4, 5 not further shown here (FIG. 10), the material of the silicone worm 15 can elastically evade into the free spaces 19, 20 without it forming into plastic deformations, in particular by the shearing of the silicone worm 15.

FIG. 5 shows a seal region 9 alternative to FIG. 4. Like elements are provided with similar reference signs.

The similar additional seal element 15 formed as silicone worm is in this example—differing from FIG. 4—adjacent to the boundary regions 17, 18 of the recessed region 14. On the contrary, sealing element 15 fills in the recessed region 14 only partially, so that avoided regions are formed round about. Also, here in particular the recessed region 14 is impressed in the distance position 11.

FIG. 6 shows one other sealing element as an alternative to FIGS. 4 and 5. Here also, like elements are provided with similar reference signs. The additional sealing element 15 likewise only partially fills in the recessed region 14. In this example nevertheless a larger boundary region 17, 18 of the recessed region 14 is discarded, whereby also excess length material 21, 22 is formed which at least partially supports itself adjacent to the functional position 13 on the distance position 11.

FIGS. 7 to 9 show a top view at the cylinder head gasket 7 on one side, in particular the seal region 9, but this time without seal element. recognizable are the reinforcing half seam 10, the recessed region 14, the recess 16 and also adjacent to recess 16 a hollow 23 introduced into the functional position 13, which forms a so-called extrusion canal for avoiding elastic material of the seal element, insofar as the recessed region 14 is not adequate for the intake of same.

FIG. 10 shows a possible use application in the installed state. Like elements are here also provided with similar reference signs. Recognizable are the cylinder block 3 and the chain housing 4 as well as the cylinder head gasket 7, shaped by means of the distance position 11 and also the functional positions 12 and 13. In the recessed region 14 of the distance position 11, the seal element 15 consisting of the silicone worm is arranged, which by bracing of the cylinder head not shown further here against the cylinder block 3 and chain housing 4 is compressed and avoids elasticity in the circumambient free space 9 (reference signs are recognizable in the drawing details).

1-11. (canceled)

12. A cylinder head gasket for an internal combustion engine, insertable for the sealing of components which has at least one of these, with at least one T-junction formed region, having at least one functional position and at least one distance position as well as at least one additional gasket element, which is provided in the region of the T-junction wherein the distance position is provided at least in the region of the T-position with at least one recessed region serving for the intake of the additional gasket element.

13. A cylinder head gasket of claim 12 wherein the gasket element protrudes over the recessed region in the direction of at least one of the sealed components.

14. A cylinder head gasket of claim 12 wherein the distance position in the region of the gasket element is associated with at least one functional position, which is provided on the gasket element side with a recess.

15. A cylinder head gasket according to claim 14, wherein the recessed region has a larger cross-section than the recess.

16. A cylinder head gasket according to claim 15, wherein at least a part of the recess is provided above the recessed region and is essentially parallel thereto.

17. A cylinder head gasket according to claim 11, wherein the recessed region is generally oval in form.

18. A cylinder head gasket according to claim 11, wherein the gasket element is arranged in such a way in the recessed region that is partially supports itself on boundary regions of the recessed region.

19. A cylinder head gasket according to claim 18, wherein the gasket element is arranged in the recessed region without contact to the boundaries of the recessed region.

20. A cylinder head gasket according to claim 18, wherein the gasket element is arranged in such a way in the recessed region that it is adjacent to partial regions of the boundary regions of the recessed region and is at least partially outside of the recessed region supporting itself on the distance position protruding above the boundary regions.

21. A cylinder head gasket according to claim 11, wherein the region of te gasket element turned towards recess of the functional position at least one hollow is provided to the recess.

22. A cylinder head gasket according to claim 1, wherein the gasket element comprises at least on silicone worm introduced in the recessed region.
